(19) United States
(12) Patent Application Publication
(10) Pub. No.: US 2025/0348894 A1
(43) Pub. Date: Nov. 13, 2025

(54) System and Method for Real-Time Monitoring and Data Analytics of Self-Serve Car Wash Operations

(71) Applicant: Matthew Cody Ohrenberg, Green Ridge, MO (US)

(72) Inventor: Matthew Cody Ohrenberg, Green Ridge, MO (US)

(21) Appl. No.: 18/656,626

(22) Filed: May 7, 2024

(51) Int. Cl. G06Q 30/0201

(52) U.S. Cl. CPC G06Q 30/0201

(57) ABSTRACT

The present invention provides an electronic monitoring system designed for self-serve car wash facilities. The system includes a housing containing a plurality of input connections, two microcontrollers, a wireless transmitter, and a power supply connection. The input connections are configured to link with outputs from a rotary switch, where each output correlates with a different wash function. The first microcontroller monitors these connections for voltage changes that indicate the activation and deactivation of the wash functions and records timestamps for each event. The second microcontroller establishes and manages a mesh network to connect with other similar devices, enhancing data relay capabilities. The wireless transmitter, powered by the power supply connection, transmits the collected data to a remote server for further analysis and management. This system is particularly beneficial for providing detailed operational data and enhancing the management capabilities of self-serve car wash facilities.

### FIELD OF INVENTION

The present invention relates generally to monitoring and data analysis systems for car wash facilities, specifically those that provide real-time, detailed usage data for self-serve car wash operations.

### BACKGROUND

In the realm of self-serve car wash facilities, the operational success hinges significantly on the ability to effectively monitor and respond to customer preferences and usage patterns. Traditional systems in this sector predominantly rely on basic mechanisms for operation control, such as coin acceptors and timers that merely activate the machinery for a predefined duration. These systems provide little to no data on which specific services are used or the sequence of their usage, resulting in a significant gap in actionable business intelligence.

Furthermore, while some advanced systems have integrated credit card payment facilities that allow for electronic tracking of sales, these too fall short of providing detailed usage data. Such systems only capture the initiation of a transaction without any insight into the specific services selected or the duration of each service's use. This limitation bars facility owners from truly understanding customer behavior, preferences, or the operational efficiency of different car wash functions.

Moreover, existing systems do not offer real-time data sharing or remote monitoring capabilities. Facility owners must be physically present to collect and analyze data, a process that is often cumbersome and delayed. The lack of immediate access to operational data also prevents timely adjustments to service offerings that could enhance customer satisfaction and operational profitability.

In light of these challenges, there is a clear and pressing need for a system that can provide comprehensive, real-time data on the usage of self-serve car wash facilities. Such a system would ideally enable owners to not only track which services are being used but also gather detailed data on the start and stop times of these services, thus offering a granular view of customer behavior. Additionally, the capability to monitor and adjust system operations remotely would significantly streamline operations and enhance responsiveness to customer needs. The development of such a system would mark a substantial advancement over the current technological landscape, setting a new standard for operational management in the self-serve car wash industry.

It is within this context that the present invention is provided.

### SUMMARY

The present invention relates to an electronic monitoring system for a self-serve car wash, which includes a device with a housing that contains a plurality of input connections, a first microcontroller, a second microcontroller, a wireless transmitter, and a power supply connection. The input connections are designed to interface with the outputs of a rotary switch, each corresponding to different wash functions within the car wash. The first microcontroller is configured to detect activation and deactivation of these functions through voltage changes and to record precise timestamps for each event. The second microcontroller is tasked with establishing and managing a mesh network with additional monitoring devices, facilitating robust data communication. The wireless transmitter enables the transmission of this data to a remote server for analysis and decision-making, powered by a suitable electrical connection.

In some embodiments, the wireless transmitter includes Wi-Fi connectivity, providing the system with the capability to transmit data directly over the internet. This feature enhances the reliability and speed of data transfer to the remote server.

In other embodiments, when Wi-Fi connectivity is unavailable, the second microcontroller can relay data through the mesh network. This ensures continuous data communication even under suboptimal network conditions, enhancing system resilience.

In further embodiments, each input connection is capable of detecting the specific type of voltage, AC or DC, used by each wash function. This adaptability allows for accurate monitoring across different types of car wash equipment that may operate under varying electrical standards.

Additionally, some embodiments include a data storage unit connected to the first microcontroller. This unit temporarily stores the recorded data before transmission, providing a buffer that stabilizes data flow to the server.

In certain embodiments, the data storage unit aggregates data based on predefined time periods, which facilitates organized and efficient data handling and analysis when transmitted to the remote server.

In yet another embodiment, the data storage unit includes flash memory, ensuring that data is not lost in the event of a power failure, thereby maintaining the integrity and continuity of operational data.

Some embodiments also feature a user interface accessible via a web platform. This interface allows users to view and manage the recorded data, offering operational insights and aiding in administrative tasks.

In related embodiments, the user interface allows users to customize settings for data reporting and alerts based on received data, providing tailored operational management and responsive maintenance capabilities.

In certain embodiments, the power supply connection is configured to utilize a standard 24V AC or DC source, common in self-serve car wash facilities, ensuring compatibility and ease of integration with existing infrastructures.

In some embodiments, the housing is designed as a water-resistant enclosure, making it suitable for the wet environments typically found in car wash facilities, thereby protecting the internal electronic components from moisture-related damage.

Further embodiments incorporate an analog-to-digital converter in the first microcontroller, which processes input signals to accurately determine the duration of each wash function's activation based on the recorded timestamps, allowing for precise usage tracking.

In additional embodiments, at least one surge protector is included among the input connections to protect the first microcontroller from potential voltage spikes during the activation and deactivation of wash functions, thereby enhancing the durability and reliability of the system.

In another embodiment, the second microcontroller includes an RF module to facilitate data transmission using radio signals within the mesh network, improving the reach and reliability of intra-device communications.

Finally, some embodiments include a voltage regulator to manage the power supply connection, adjusting the input voltage to a safe operating level for the microcontrollers and wireless transmitter, thereby ensuring stable operation and prolonging the lifespan of the electronic components.

### BRIEF DESCRIPTION OF THE DRAWINGS

Various embodiments of the invention are disclosed in the following detailed description and accompanying drawings.

FIG. 1 illustrates an example wiring diagram showing the connections between the monitoring system of the invention, and a bay timer, a rotary switch, and a pump stand within a car wash system.

FIG. 2 illustrates an example block diagram of a single device housing all the necessary components of the monitoring system, including microcontrollers and a wireless transmitter.

FIG. 3A illustrates an example cross-sectional view of the monitoring device housing, showing how the top and bottom parts are secured together.

FIG. 3B illustrates an example isometric view of the monitoring device housing, highlighting the mounting mechanism for securing the device to a surface.

FIG. 4 illustrates an example system architecture showing multiple monitoring devices interconnected via a mesh network and communicating with a web server and user devices for data analytics display.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The terms “first,” “second,” and the like are used to distinguish different elements or features, but these elements or features should not be limited by these terms. A first element or feature described can be referred to as a second element or feature and vice versa without departing from the teachings of the present disclosure.

For the purposes of this patent application, the term “electronic monitoring system” refers to any device or set of devices capable of electronically detecting, recording, and transmitting data related to the operational parameters of self-serve car wash facilities. This includes but is not limited to systems that monitor electrical signals to detect the activation and deactivation of mechanical functions within a car wash facility.

The term “input connections” as used herein refers to any means of electrical connection designed to interface with control systems of car wash equipment, including but not limited to rotary switches that activate various wash functions. These connections are capable of transmitting signals indicative of voltage changes that are interpreted by the system's microcontroller(s).

The term “mesh network” in this context refers to a network configuration wherein each node (i.e., each electronic monitoring device within the system) relays data for the network. All nodes cooperate in the distribution of data in the network. Example communication protocols for such a mesh network include but are not limited to Bluetooth Low Energy (BLE), Zigbee, and Wi-Fi Direct. These protocols facilitate the creation of robust, self-healing networks that maintain interconnectivity between devices even when some nodes encounter connectivity issues.

The term “wireless transmitter” encompasses any component or set of components capable of sending digital data via electromagnetic waves. This includes components operating on various frequencies and protocols, such as Wi-Fi (802.11 standards), LTE, or other RF (radio frequency) technologies.

Regarding the “power supply connection,” it is to be understood as referring to any system or mechanism capable of providing electrical power to the electronic monitoring system. This can include connections to standard 24V AC or DC power sources commonly used in car wash facilities. Additionally, alternative power sources such as solar panels or battery backups may be used to ensure continuous operation during power outages or interruptions.

### DESCRIPTION OF DRAWINGS

The present invention relates to an electronic monitoring system specifically designed for self-serve car wash operations. This invention addresses a need within the car wash industry for more granular and actionable data regarding the usage of car wash facilities. By providing detailed insights into which services are utilized and the duration of each service, this system enables car wash operators to better understand customer preferences and optimize their service offerings accordingly.

The system is comprised of one or more devices including input connections, microcontrollers, a wireless transmitter, and a power supply mechanism, all housed within a durable enclosure suitable for the challenging environment of a car wash. The first microcontroller in the system is tasked with detecting and logging the activation and deactivation of various wash functions as signalled through voltage changes at the input connections. These inputs are typically linked to a rotary switch used by customers to select different wash functions. Each operational event detected by the system is time-stamped, providing a precise record of wash function usage. A second microcontroller is included to manage and facilitate a mesh network among multiple devices installed across different wash stations. This network capability ensures that data can be relayed and aggregated even in scenarios where direct internet connectivity might be compromised or unavailable.

By integrating the system of the invention, car wash operators are provided with a tool that not only enhances the operational efficiency of their facilities but also significantly improves their ability to cater to customer needs and preferences, ultimately leading to increased customer satisfaction and business profitability.

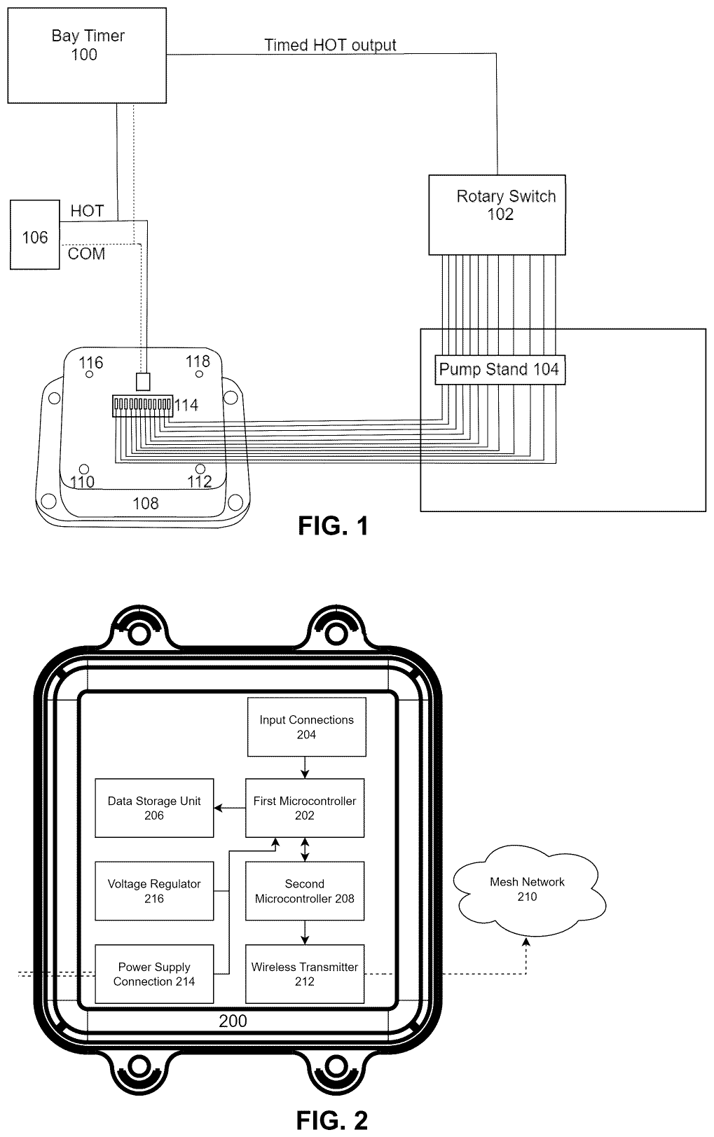

Referring to FIG. 1, an example configuration is shown of a self-serve car wash with the monitoring system and device of the invention installed. The configuration includes a bay timer 100, a rotary switch 102, and connections to a pump stand 104. The rotary switch and bay timer are typically part of the existing infrastructure of a self-serve car wash system, rather than being components of the invention itself.

In self-serve car wash setups, the bay timer manages the timing of each washing cycle. When a customer inserts payment (coins, tokens, or card payments), the bay timer is activated for a predetermined duration, powering the system to allow for the selection and use of various wash functions. The bay timer controls the overall operation, ensuring that the car wash functions are active only during the paid time. The rotary switch allows the customer to select different car wash functions such as soap, rinse, wax, etc. It usually works in tandem with the bay timer. Once the bay timer is activated, the rotary switch can direct the power to specific functions based on the customer's selection. Each position of the rotary switch corresponds to a different function, channeling the electrical power to activate the corresponding pumps, solenoids, or other mechanisms necessary for that particular function.

In the figure, the bay timer 100 is configured to send a timed output signal to the rotary switch 102. This signal is typically “hot” indicating that power is being sent from the bay timer 100 to the rotary switch 102. The connection from the bay timer 100 to the rotary switch 102 is facilitated via a wiring setup that includes a transformer 106, typically a 24V transformer suitable for both AC and DC systems, and a COM line (shown as dashed), providing flexibility depending on the power setup of the specific car wash station.

The rotary switch 102 is a 12-position switch, each position corresponding to a different wash function such as soap, rinse, or wax. These positions are connected via multiple lines to the pump stand 104, which is responsible for activating the various functions of the car wash. Each line from the rotary switch 102 to the pump stand 104 carries the power necessary to activate different pumps or solenoids that control the water, soap, and other fluids used in the car wash process.

Additionally, an output from the rotary switch 102 is directed towards a wash analytics monitoring device 108. This monitoring device is part of the electronic monitoring system of the invention that records and analyzes usage data. It collects data on which positions of the rotary switch 102 are used and the duration of each usage. This information is helpful for understanding customer preferences and optimizing the car wash service offerings.

In the present example, the monitoring device 108 has a pair of LED indicators on its exterior, one 110 to show when the mesh network is active, and another 112 to show when the system is connected via the inputs 114. It also has a pair of controls, a restart button 116 and a setup configuration button 118

Referring to FIG. 2, an example configuration is shown of a single device housing 200 of the electronic monitoring system for a self-serve car wash.

Inside the device housing 200, a first microcontroller 202 is installed, which serves as the primary processing unit of the system. The first microcontroller 202 is electrically connected to a plurality of input connections 204. These input connections 204 are configured to interface directly with the outputs of the rotary switch from the car wash facility (not shown in this figure). Each input connection 204 corresponds to a different wash function such as spraying, soaping, or drying, and is capable of detecting voltage changes that signal the activation and deactivation of these functions.

The first microcontroller 202 is also connected to a data storage unit 206, which temporarily stores the timestamps and other relevant data pertaining to the usage of the wash functions. This stored data is prepared for subsequent transmission and can be aggregated or processed locally before sending it off to a remote server.

Adjacent to the first microcontroller 202, a second microcontroller 208 is present. This second microcontroller 208 is dedicated to communication tasks, specifically managing a mesh network 210 with other similar devices. The mesh network 210 allows the device to communicate with a central server or other devices even in cases where direct internet connectivity is compromised. This is particularly useful for ensuring data redundancy and reliability.

For data transmission purposes, a wireless transmitter 212 is incorporated within the housing 200 and is connected to the first microcontroller 202. The wireless transmitter 212 is responsible for sending the collected data to a remote server via Wi-Fi or other RF communication methods, allowing real-time monitoring and analysis of the data collected from the car wash operations.

The entire system within the device housing 200 is powered through a power supply connection 214. This connection 214 is designed to be compatible with standard 24V AC or DC power sources commonly used in self-serve car wash facilities, ensuring that the device can be easily integrated into existing setups without the need for additional power solutions.

Additionally, the device housing 200 includes a voltage regulator 216, which ensures that all internal components receive stable and safe power levels despite the potentially fluctuating input power. This is necessary for maintaining the integrity and longevity of the microcontrollers and other sensitive electronic components.

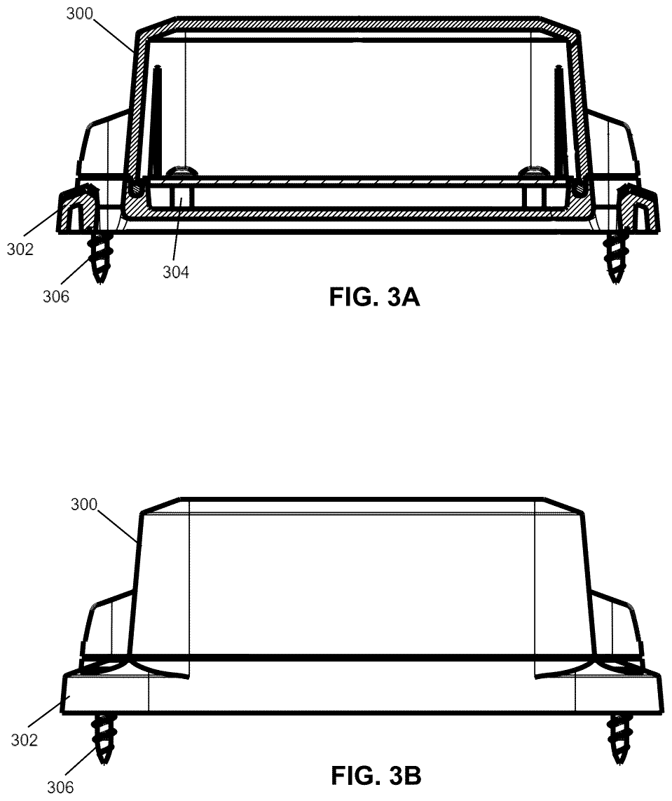

Referring to FIG. 3A and FIG. 3B, an example configuration is shown of a housing for the electronic monitoring device used in self-serve car wash operations. The housing is designed to ensure both durability and functionality in the moist environment typical of car wash facilities.

FIG. 3A depicts a cross-sectional view of the housing, highlighting its internal structure. The housing comprises a top part 300 and a bottom part 302, which are joined together to create a waterproof internal hollow space. This space is for housing the electronic components such as microcontrollers, input connections, a wireless transmitter, and power supply mechanisms safely away from moisture. The top part 300 and the bottom part 302 are secured together using a first set of screws 304, which ensure a tight seal to maintain the waterproof integrity of the housing.

FIG. 3B shows an isometric view of the housing, providing a clearer picture of its external features. The mounting mechanism of the housing includes a second set of screws 306 that allow the bottom part 302 to be securely attached to a surface within the car wash facility, such as near the wash bays or control panels. This mounting mechanism is designed to provide stability and prevent displacement due to the high-pressure environment of car wash operations.

The materials used for the housing are selected for their corrosion-resistant properties and strength, ensuring that the housing can withstand both the chemical exposure and physical impacts typical in a car wash setting. The screws in both the first set 304 and second set 306 are typically made of stainless steel or another rust-resistant material to further enhance the durability and longevity of the installation. This housing configuration not only protects the internal electronics from water and chemical damage but also simplifies the installation and maintenance process, making it practical for widespread use in various car wash facilities.

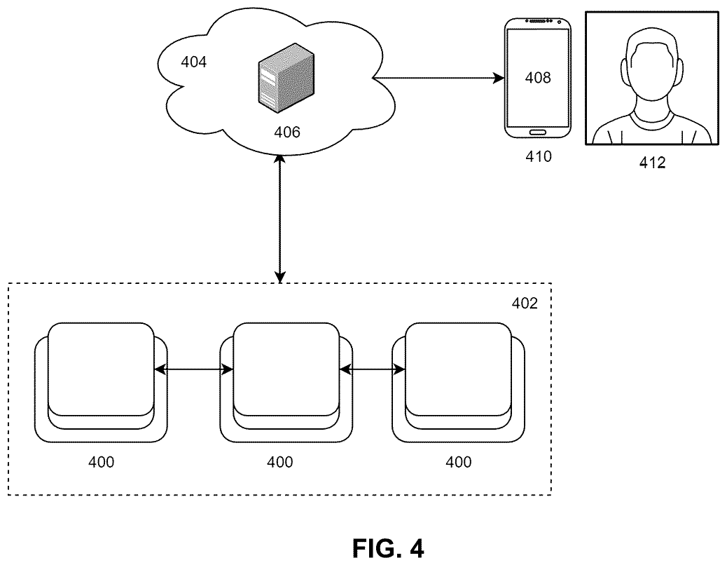

Referring to FIG. 4, an example system architecture is shown of a network configuration involving multiple monitoring devices, each installed in separate machines within the same car wash facility, although the car wash machines themselves are not depicted in this figure.

Each monitoring device 400 is connected to the outputs of a rotary switch at their respective car wash stations. These connections enable the devices to monitor which car wash functions are being used and detect voltage changes that indicate the activation and deactivation of these functions. The microcontroller within each monitoring device 400 records each activation and deactivation event with a timestamp, providing detailed information on when each function was used, the duration of use, and the sequence of function usage.

The microcontrollers in the monitoring devices 400 process the raw input data locally to organize it into structured formats. This might involve grouping data by individual washing sessions or specific inputs and calculating the duration of each function's use. The processed data is temporarily stored in the devices' onboard memory, acting as a buffer until it can be transmitted to the webserver.

In terms of data transmission, the monitoring devices 400 are part of a mesh network 404, which allows the devices to communicate with each other and relay data to a central device that has internet connectivity. This mesh network 402 ensures that all data reaches the webserver 406 (which in the present example is part of a cloud network 404), even if direct Wi-Fi connectivity is temporarily unavailable for some units.

The webserver 406 receives data transmitted from each monitoring device 400. It stores this data in a cloud database, organizing it based on the source device, timestamp, and type of data. The server 406 processes the data further if necessary, such as aggregating statistics over daily, weekly, or monthly periods, and preparing it for visualization.

Users 412 interact with this system through their user devices 410 which can access the data via a user interface 408 presented on a web platform. This interface includes a dashboard that car wash owners can use to view the processed data in an easily digestible format, such as graphs, charts, and tables. The platform provides various analytical tools that allow owners to parse through the data to reveal trends in usage, peak usage times, and comparisons between different functions or time periods.

The setup also allows for real-time updates and user configurations. Users can customize settings on the dashboard, defining what data to display, setting alerts for specific thresholds or anomalies, and configuring how often they want the device to transmit data to the server. Additionally, the platform can send configuration changes back to the monitoring devices 400, enabling remote updates and adjustments to the system's operation.

### Controller/Processor Components

A microcontroller or processor as described herein can be any suitable type. Furthermore, the computer operating the described web interface may be a uniprocessor or multiprocessor machine. Accordingly, computing devices referred to herein may be any suitable device including one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the electronic monitoring system and related methods of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An electronic monitoring system for a self-serve car wash, comprising at least one device having:
a housing;
a plurality of input connections on the housing exterior configured to connect to corresponding outputs of a rotary switch, each output corresponding to a different wash function of the self-serve car wash;
a first microcontroller within the housing and electrically coupled to the plurality of input connections, configured to detect voltage changes indicating activation and deactivation of the wash functions, and to record timestamps corresponding to the start and stop times of each wash function usage;
a second microcontroller within the housing configured to establish and manage a mesh network with one or more other electronic monitoring devices;
a wireless transmitter within the housing and connected to the first microcontroller, configured to transmit the recorded timestamps and corresponding wash function data to a remote server;
a power supply connection configured to supply electrical power to the first microcontroller, the second microcontroller, and the wireless transmitter.

2. The electronic monitoring system of claim 1, wherein the wireless transmitter includes Wi-Fi connectivity to directly connect the first microcontroller to the internet for transmitting data.

3. The electronic monitoring system of claim 2, wherein the second microcontroller is further configured to relay data to the remote server through the mesh network when Wi-Fi connectivity is unavailable.

4. The electronic monitoring system of claim 1, wherein each input connection is further configured to detect the specific type of voltage used by the corresponding wash function, whether alternating current (AC) or direct current (DC).

5. The electronic monitoring system of claim 1, further comprising a data storage unit connected to the first microcontroller, configured to temporarily store the recorded timestamps and corresponding wash function data prior to transmission.

6. The electronic monitoring system of claim 5, wherein the data storage unit is configured to aggregate data based on predefined time periods before transmission to the remote server.

7. The electronic monitoring system of claim 5, wherein the data storage unit includes flash memory capable of retaining data in the event of a power loss to the system.

8. The electronic monitoring system of claim 1, further comprising a user interface accessible via a web platform, configured to allow a user to view and manage the recorded timestamps and corresponding wash function data.

9. The electronic monitoring system of claim 8, wherein the user interface is further configured to allow the user to customize settings for data reporting and alerts based on the data received from the electronic monitoring system.

10. The electronic monitoring system of claim 1, wherein the power supply connection is configured to receive power from a standard 24V AC or DC source used in self-serve car wash facilities.

11. The electronic monitoring system of claim 1, wherein the housing is a water-resistant enclosure suitable for use in wet environments of self-serve car wash facilities.

12. The electronic monitoring system of claim 1, wherein the first microcontroller is further configured to process input signals through an analog-to-digital converter to determine the duration of each wash function's activation based on the recorded timestamps.

13. The electronic monitoring system of claim 1, wherein the plurality of input connections includes at least one surge protector configured to protect the first microcontroller from voltage spikes associated with the activation and deactivation of the wash functions.

14. The electronic monitoring system of claim 1, wherein the second microcontroller includes an RF (radio frequency) module configured to facilitate data transmission between devices in the mesh network using radio signals.

15. The electronic monitoring system of claim 1, further comprising a voltage regulator configured to manage the power supply connection by adjusting the input voltage to a safe operating level for the microcontrollers and the wireless transmitter.
